(19) United States
(12) Patent Application Publication
(10) Pub. No.: US 2014/0125613 A1
(43) Pub. Date: May 8, 2014

(54) TOUCH DETECTION DEVICE, DISPLAY DEVICE, AND TOUCH DETECTION METHOD

(71) Applicant: Panasonic Liquid Crystal Display Co., Ltd., Himeji-shi (JP)

(72) Inventors: Natsuki KOMATSU, Hokkaido (JP); Nobumichi TAKABA, Hokkaido (JP); Takatsugu YAMAGATA, Hokkaido (JP); Shingo ARIKAWA, Hokkaido (JP); Satoshi HIROTSUNE, Hyogo (JP); Akihiro YAMAMURA, Osaka (JP)

(73) Assignee: Panasonic Liquid Crystal Display Co., Ltd., Himeji-shi (JP)

(21) Appl. No.: 14/071,132

(22) Filed: Nov. 4, 2013

(30) Foreign Application Priority Data
Nov. 5, 2012 (JP) 2012-243379

(51) Int. Cl. G06F 3/041

(52) U.S. Cl. CPC G06F 3/041
USPC 345/173

(57) ABSTRACT

A touch detection device includes a touch panel including a first electrode part arranged so as to extend in a first direction and a second electrode part arranged so as to extend in a second direction that is different from the first direction. The touch detection device also includes a pulse generating unit configured to output a pulse signal to the first electrode part, a resistance element arranged between an output terminal of the pulse generating unit and the first electrode part, and a touch detecting unit configured to detect whether the touch panel is touched or not based on a phase difference in a voltage signal of the second electrode part, which is generated in accordance with the pulse signal. The phase difference is based on whether the touch panel is touched or not.

### CROSS-REFERENCE TO RELATED APPLICATION

The present application claims priority from Japanese Application JP2012-243379. This Japanese application is incorporated by reference into this application.

### BACKGROUND OF THE INVENTION

1. Field of the Invention

The present invention is related to a touch detection device, a display device, and a touch detection method.

2. Description of the Related Art

Capacitive coupling is known as one detection scheme in a touch panel device for detecting a touch location on a touch panel. The touch panel includes, for example, a plurality of X electrodes and Y electrodes in the X direction and Y direction. When a drive voltage is applied to the X electrodes, an electrical charge is charged to a capacitance that is generated between the X electrodes and the Y electrodes, and the voltage value increases. Here, the duration of time until a predetermined reference voltage value is reached is measured. Since an electrical charge flows from the electrodes into a finger when the touch panel is touched, the duration of time until the reference voltage is reached becomes longer. Thereby, since the duration of time that is measured differs depending on the presence of a touch, the presence of a touch is determined based on this difference. (Refer to Japanese Unexamined Patent Application, First Publication No. 2011-113506.)

### SUMMARY OF THE INVENTION

However, in the above-described touch panel device, a comparator for determining whether the predetermined reference voltage value has been reached and a switching circuit for discharging an electrical charge that was charged for detecting the presence of a touch at the next timing are necessary, and thus the circuit constitution becomes complex. Further, charging and discharging of the electrical charge are necessary, and thus it is difficult to detect the presence of a touch at high speed. In particular, if the time constant of the circuit is large, the charge time increases, and thus detecting at high speed is even more difficult.

In view of the above-described problems, one or more embodiments of the present invention realize a touch detection device and a touch detection method, which detect the presence of a touch at higher speed without increasing the complexity of the circuit constitution.

(1) In one or more embodiments of the present invention, a touch detection device includes a touch panel. The touch panel includes a first electrode part arranged so as to extend in a first direction, and a second electrode part arranged so as to extend in a second direction that is different from the first direction. The touch panel also includes a pulse generating unit configured to output a pulse signal to the first electrode part, a resistance element arranged between an output terminal of the pulse generating unit and the first electrode part, and a touch detecting unit configured to detect whether the touch panel is touched or not based on a phase difference in a voltage signal of the second electrode part, which is generated in accordance with the pulse signal. The phase difference is based on whether the touch panel is touched or not.

(2) In the touch detection device according to (1), the voltage signal is a voltage signal by a parasitic capacitance of the first electrode part, a parasitic capacitance of the second electrode part, and a capacitance voltage division based on the first electrode part and the second electrode part.

(3) In the touch detection device according to (1) or (2), the touch detecting unit includes a sampling unit configured to perform 1-bit sampling of a voltage signal output from the second electrode part based on a predetermined reference value, a digital filter configured to remove noise included in a voltage signal output from the sampling unit, and a touch determining unit configured to detect whether the touch panel is touched or not based on a level of a voltage signal output from the digital filter.

(4) In the touch detection device according to (3), the touch detection device further comprises an adjusting unit configured to increase a level difference in the voltage signal output from the digital filter. The touch determining unit detects whether the touch panel is touched or not based on a level of a voltage signal output from the adjusting unit.

(5) In the touch detection device according to (4), the adjusting unit includes an offset setting unit configured to offset a voltage value of a voltage signal output from the digital filter.

(6) In the touch detection device according to (4) or (5), the adjusting unit includes again setting unit configured to adjust a gain of a voltage signal output from the digital filter.

(7) In the touch detection device according to one of (1) to (6), the touch detection device includes a level adjusting unit that is arranged between the second electrode part and the touch detecting unit and adjusts a voltage value of a voltage signal output from the second electrode part.

(8) In the touch detection device according to one of (1) to (7), the first electrode part includes a plurality of first electrodes arranged in a line in the first direction, the second electrode part includes a plurality of second electrodes arranged in a line in the second direction, the first electrode part and the second electrode part are arranged to intersect each other, and the touch detecting unit detects a location of a touch on the touch panel based on each phase difference of each voltage signal of the plurality of second electrodes generated in accordance with pulse signals output to the plurality of first electrodes. The phase difference is based on whether the touch panel is touched or not.

(9) In the touch detection device according to one of (1) to (8), the touch detection device is provided in a TFT substrate of a display device.

(10) In one or more embodiments of the present invention, a display device includes the touch detection device according to one of (1) to (9).

(11) One or more embodiments of the present invention are directed to a touch detection method of a touch detection device. The touch detection device includes a touch panel including a first electrode part arranged so as to extend in a first direction and a second electrode part arranged so as to extend in a second direction that is different from the first direction. The touch detection device also includes a resistance element arranged between an output terminal of a pulse generating unit and the first electrode part. The touch detection method includes outputting a pulse signal to the first electrode part, and detecting whether the touch panel is touched or not based on a phase difference in a voltage signal of the second electrode part, which is generated in accordance with the pulse signal. The phase difference is based on whether the touch panel is touched or not.

### BRIEF DESCRIPTION OF THE DRAWINGS

FIG. 1 is a diagram explaining the overall constitution of a touch panel device in one embodiment of the present invention.

FIG. 2 illustrates one example of the shape of the X electrodes and Y electrodes in the touch panel.

FIG. 3 is an enlarged schematic view of the portion surrounded by dashed lines in FIG. 2.

FIG. 4 schematically illustrates one example of a cross-section along line IV-IV in FIG. 2.

FIG. 5 illustrates one example of a pulse signal output from a pulse generator.

FIG. 6 is a diagram explaining in further detail of the constitution and operation of the touch panel device shown in FIG. 1.

FIG. 7A illustrates one example of noise removal.

FIG. 7B illustrates one example of noise removal.

FIG. 7C illustrates one example of noise removal.

FIG. 8 schematically illustrates the rising wave shapes of an output voltage VOUT shown in FIG. 6.

FIG. 9 is a diagram for explaining one example of 1-bit sampling.

FIG. 10 is a diagram for explaining one example of digital filter processing.

FIG. 11 is a diagram for explaining a touch detector in an alternative embodiment of the present invention.

FIG. 12 is a diagram for explaining offset and gain adjustment in an alternative embodiment of the present invention.

### DETAILED DESCRIPTION OF THE INVENTION

Embodiments of the present invention will be explained below referring to the drawings. With regard to the drawings, identical or equivalent elements are assigned the same reference numerals, and redundant explanations thereof will be omitted.

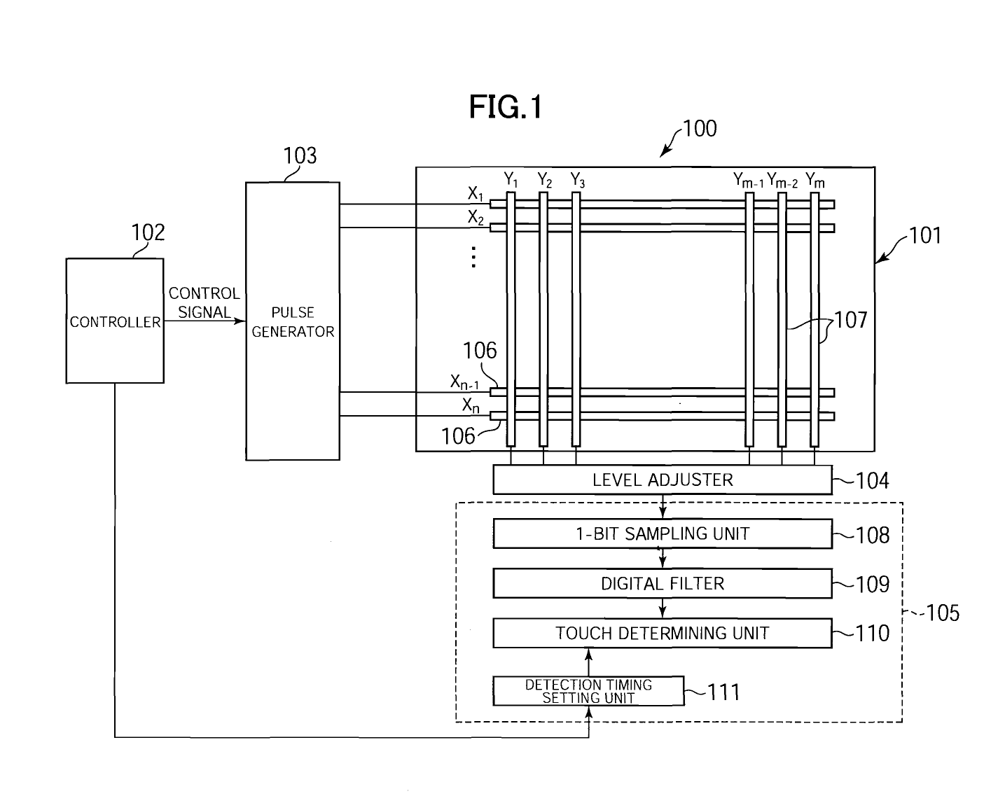

FIG. 1 is a diagram for explaining the overall constitution of a touch panel device in one embodiment of the present invention. As shown in FIG. 1, a touch panel device 100 includes, for example, a touch panel 101, a controller 102, a pulse generator 103, a level adjuster 104, and a touch detector 105. Parts 102 to 105 excluding the touch panel 101 may be constituted by, for example, a single controller. Although omitted in FIG. 1, the touch panel device 100 further includes a resistance element which will be explained later.

The touch panel 101 includes a plurality of X electrodes 106 arranged extending in an X direction (row direction) and a plurality of Y electrodes 107 arranged extending in a Y direction. Specifically, for example, when viewing from above FIG. 1, the X electrodes 106 and Y electrodes 107 are arranged at approximately equal intervals such that they are approximately orthogonal to each other.

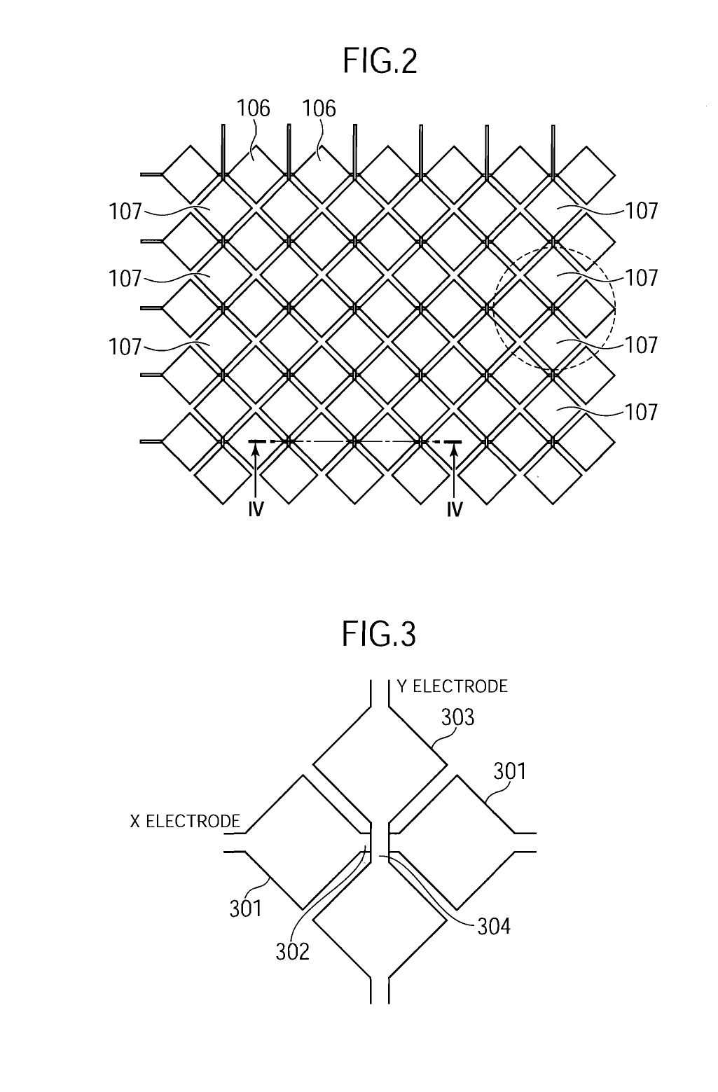

In addition to the bar-shaped electrodes shown in FIG. 1, the X electrodes 106 and the Y electrodes 107 may be configured in, for example, a so-called diamond structure in which square-shaped electrodes are formed to be continuous near two vertices thereof as shown in FIG. 2.

FIG. 3 is an enlarged schematic view of the portion surrounded by dashed lines in FIG. 2. As shown in FIG. 3, the X electrodes 106 have a shape in which square-shaped X electrode parts 301 are sequentially continuous via an X wiring part 302. Similarly, the Y electrodes 107 have a shape in which square-shaped Y electrode parts 303 are sequentially continuous via a Y wiring part 304. The X electrodes 106 and the Y electrodes 107 are arranged apart from each other via an interlayer insulating layer 403.

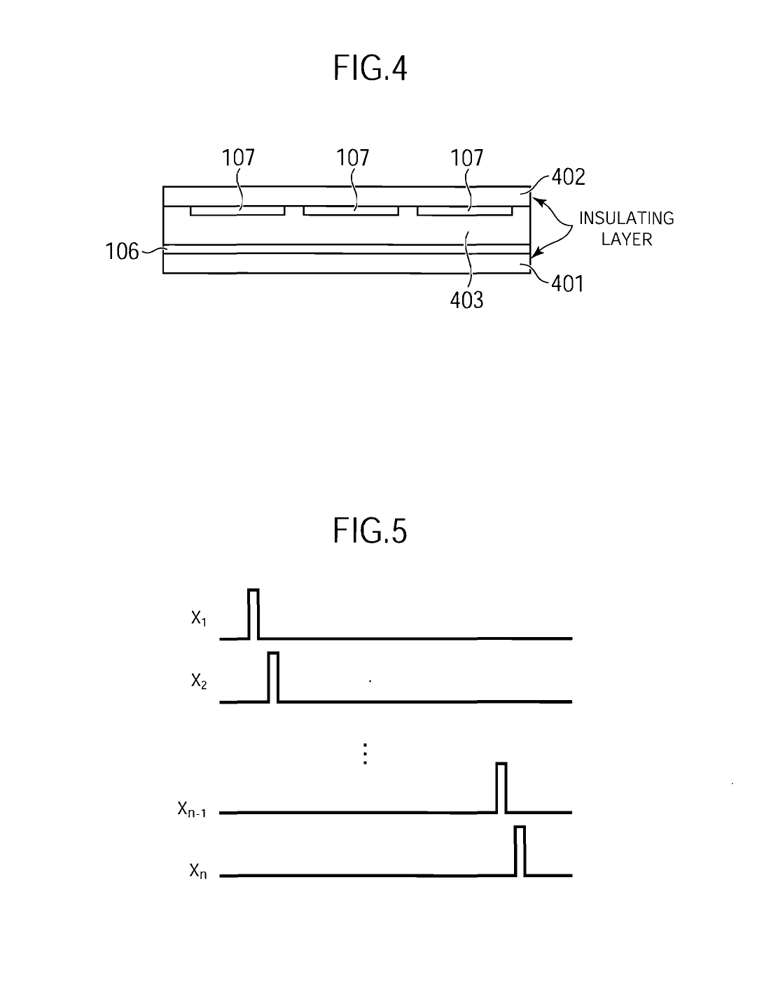

In detail, as shown in FIG. 4, for example, the X electrodes 106 are arranged in a bottom-side insulating layer 401 and the Y electrodes 107 are arranged in a top-side insulating layer 402. The X electrodes 106 and the Y electrodes 107 are, for example, spaced apart via the interlayer insulating layer 403 which is arranged between the bottom-side and top-side insulating layers. FIG. 4 schematically illustrates one example of a cross-section along line IV-IV in FIG. 2.

The controller 102 outputs a control signal to the pulse generator 103 to control the pulse generator 103. Specifically, for example, the controller 102 outputs a synchronizing signal regarding the timing during a horizontal scan interval and a vertical scan interval to the pulse generator 103 as a control signal.

The pulse generator 103 outputs pulse signals sequentially to the plurality of X electrodes 106 based on the control signal from the controller 102. Specifically, for example, as shown in FIG. 5, the pulse generator 103 outputs pulse signals sequentially from an X1 electrode 106 to an Xn electrode 106. Herein, n is an integer of 1 or more.

The level adjuster 104 adjusts a voltage level of each voltage signal output to the plurality of Y electrodes 107. Specifically, for example, the level adjuster 104 adjusts the voltage level of the Y electrodes 107 such that the voltage signal reaches a reference voltage of a 1-bit sampling unit 108 to be explained later.

Specifically, for example, the voltage level may be adjusted by offsetting it through amplification by an amp, or the voltage level may be adjusted by offsetting it using a resistor. In the constitution explained above, the level adjustment by the level adjuster 104 is carried out on the Y electrode 107 side. However, the level adjuster 104 may be provided on the X electrode 106 side to adjust the voltage level of the voltage signals output to the plurality of Y electrodes 107.

The touch detector 105 detects the presence of a touch and the location which is touched on the touch panel 101 based on a phase difference in the voltage signals of the Y electrodes 107 based on the presence of a touch. Specifically, voltage signals are generated in the Y electrodes 107 based on the above-mentioned pulse signals, and a phase difference of the voltage signals differs due to whether the touch panel 101 is touched or not. Thus, by detecting the phase difference, the presence of a touch and the like on the touch panel 101 is detected.

Herein, one example of the specific constitution of the touch detector 105 will now be explained. As shown in FIG. 1, the touch detector 105 includes, for example, a 1-bit sampling unit 108, a digital filter 109, a touch determining unit 110, and a detection timing setting unit 111.

For example, the 1-bit sampling unit 108 performs 1-bit sampling on the voltage signals output from the level adjuster 104 based on a predetermined reference voltage. Specifically, for example, when the voltage signals are equal to or greater than the predetermined reference value, a high voltage is output, and when the voltage signals are less than the predetermined reference value, a low voltage that is lower than the high voltage is output.

The digital filter 109 removes a noise component included in the voltage signals that are 1-bit sampled as described above. Specifically, for example, the digital filter 109 is configured to remove components other than a frequency component of the pulse signals from the voltage signals.

The touch determining unit 110 determines the presence of a touch based on the voltage signals output from the digital filter 109 in accordance with a detection timing generated by the detection timing setting unit 111 to be explained later. Specifically, for example, since a potential difference of the voltage signals differs depending on the presence or absence of a touch, the presence of a touch is determined based on whether a voltage value of the voltage signal at the detection timing is equal to or greater than a predetermined reference value.

The detection timing setting unit 111 is, for example, a timer counter, and it acquires a control signal from the controller 102. The detection timing setting unit 111 outputs a detection timing of the voltage signals to the touch determining unit 110 based on the control signal. In FIG. 1, a single voltage signal of the level adjuster 104 that is output from the level adjuster 104 is shown, but the touch location on the touch panel 101 is detected by detecting the presence of a touch as explained above for the voltage signals.

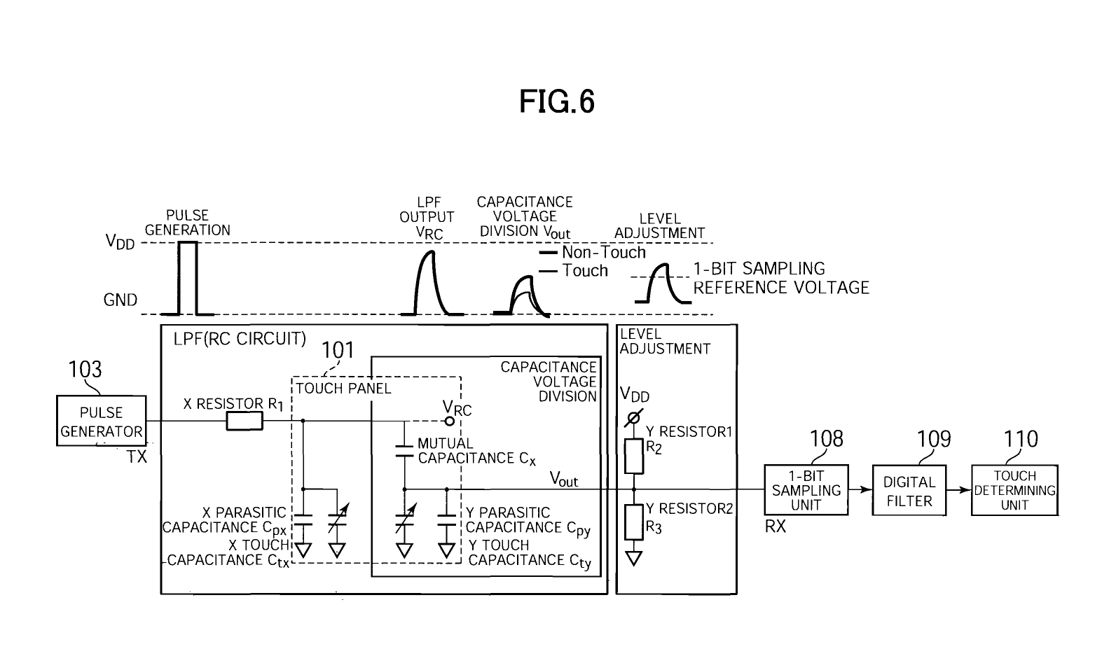

Next, the constitution and operation of the touch panel device 100 according to the present embodiment will be explained in further detail using FIG. 6. The explanation regarding FIG. 6 will focus on a single X electrode 106 and a single Y electrode 107 among the plurality of X electrodes 106 and Y electrodes 107 shown in FIG. 1 in order to simplify the explanation.

As shown in FIG. 6, the pulse generator 103 outputs a pulse signal to the X electrode 106 in accordance with a control signal from the controller 102. In FIG. 6, a voltage value of a high voltage of the pulse signal is denoted as VDD and a low voltage is denoted as GND.

Although omitted in FIG. 1, the touch panel device 100 includes a resistance element (X resistor R1) between the pulse generator 103 and the X electrodes 106.

As shown in FIG. 1, the touch panel 101 includes an X parasitic capacitance CPX and an X touch capacitance CTX. Herein, the X parasitic capacitance CPX is a parasitic capacitance of the X electrodes 106, and corresponds, for example, to a parasitic capacitance generated between a TFT substrate or the like (not illustrated) included in the touch panel device 100 and the X electrodes 106. Further, the X touch capacitance CTX corresponds to a capacitance generated by a touch on the touch panel 101.

Similarly, the touch panel 101 also includes a Y parasitic capacitance CPY and a Y touch capacitance CTY. Here, the Y parasitic capacitance CPY is a parasitic capacitance of the Y electrodes 107, and corresponds, for example, to a parasitic capacitance generated between a TFT substrate or the like included in the touch panel device 100 and the Y electrodes 107. Further, the Y touch capacitance CTY corresponds to a capacitance generated by a touch on the touch panel 101.

The touch panel 101 further includes a mutual capacitance CX generated between the X electrodes 106 and the Y electrodes 107. The X touch capacitance CTX and the Y touch capacitance CTY are generated by a touch as described above, and these capacitances are not generated when there is no touch. Further, the mutual capacitance CX decreases in accordance with a touch on the touch panel 101 by, for example, a finger or the like.

As shown in FIG. 6, the X resistor R1 is grounded via the X parasitic capacitance CPX and the X touch capacitance CTX. The X resistor R1 is also grounded via the mutual capacitance CX, the Y parasitic capacitance CPY, and the Y touch capacitance CTY. Further, the Y parasitic capacitance CPY and the Y touch capacitance CTY are connected in parallel, and the mutual capacitance CX is connected in series to the Y parasitic capacitance CPY and the Y touch capacitance CTY which are connected in parallel. In addition, an output terminal VOUT from the touch panel 100 is provided between the mutual capacitance CX, and, the Y parasitic capacitance CPY and the Y touch capacitance CTY, which are connected in parallel. The output terminal VOUT is connected to the touch detector 105 via the level adjuster 104.

Here, a low-pass filter (LPF (RC circuit)) is formed by the X resistor R1 and the capacitances of the touch panel 101. Therefore, a high frequency component including noise is removed from the pulse signals from the pulse generator 103 by the low-pass filter as shown in FIG. 6, and the rise takes on a smooth wave shape (refer to VRC in FIG. 6).

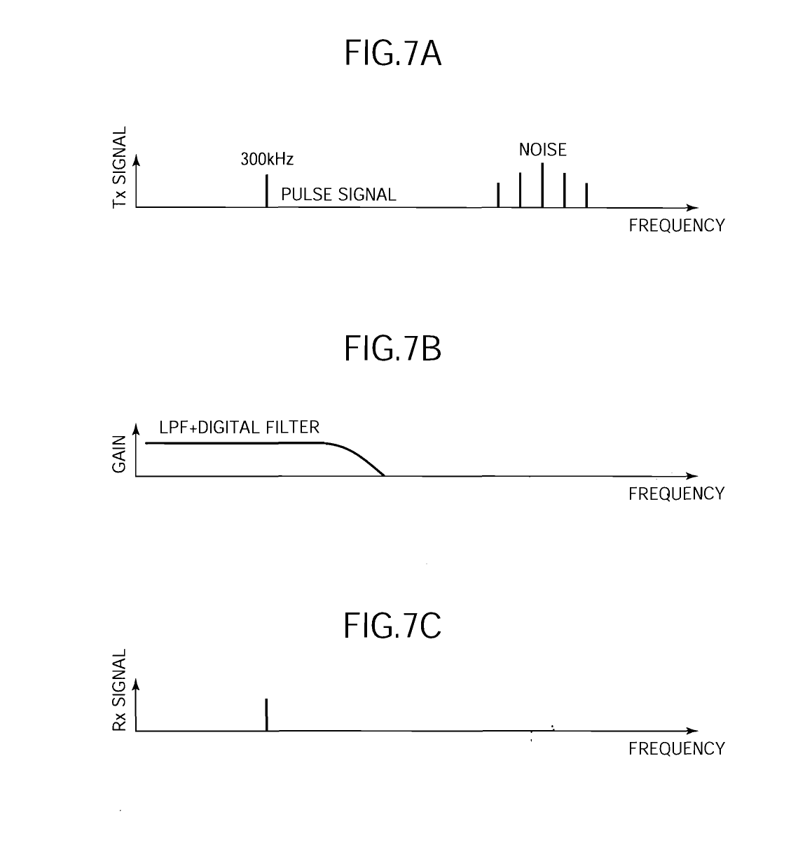

As shown in FIG. 7, the noise component is removed by the low-pass filter. FIG. 7A illustrates one example of the relationship between a pulse signal (TX) output from the pulse generator 103 and the frequency, FIG. 75 illustrates one example of the relationship between the gain by the low-pass filter and the digital filter 109, and, the frequency, and FIG. 7C illustrates one example of a pulse signal from which the noise component has been removed by the low-pass filter and the digital filter. In FIG. 7, the frequency of the pulse signal is illustrated as, for example, 300 kHz.

The VRC corresponding to the output voltage of the low-pass filter is further subjected to capacitance voltage division by the mutual capacitance CX, the Y parasitic capacitance CPY, and the Y touch capacitance CTY of the touch panel 101. Thereby, as shown in FIG. 6, the voltage value becomes smaller than the VRC and it is output as an output voltage VOUT from the touch panel 101. Specifically, the VRC is subjected to capacitance voltage division as shown in the following formula by the mutual capacitance CX, the Y parasitic capacitance CPY, and the Y touch capacitance CTY.

$${V}_{out} = \frac{{C}_{x}}{{C}_{x} + {C}_{py} + {C}_{ty}} {V}_{RC} \qquad [ Formula 1 ]$$

As described above, when the touch panel 101 is touched, the mutual capacitance CX becomes smaller and the Y touch capacitance CTY is generated. Therefore, the output voltage VOUT (the capacitance voltage division VOUT in FIG. 6) in the case in which the touch panel 101 is touched as shown in FIG. 6 exhibits a slower rise in the wave shape compared to the casein which the touch panel 101 is not touched, and the upper limit value of the voltage also decreases.

The output voltage VOUT is adjusted by the level adjuster 104 so that the level of the voltage value includes the reference voltage (1-bit sampling reference voltage) of the 1-bit sampling unit 108 as shown in FIG. 6. In FIG. 6, a case in which the level adjuster 104 is constituted using resistors R2 and R3 and a voltage source VDD is explained. However, as mentioned above, the level adjuster 104 may have a different constitution such as using amplification by an amp.

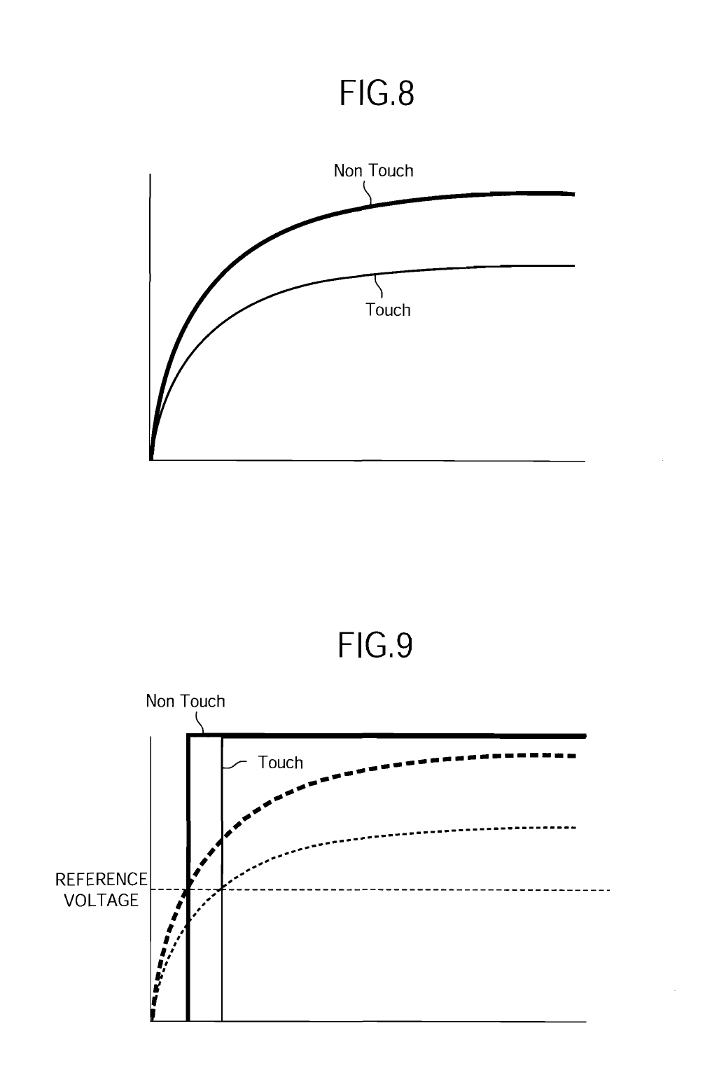

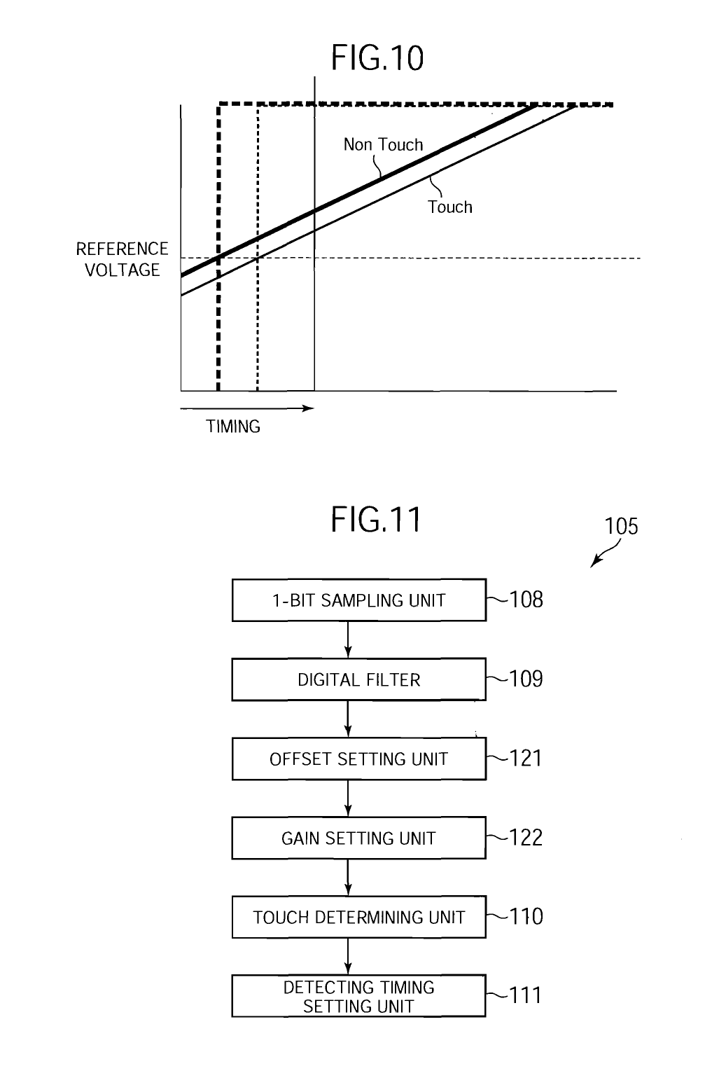

FIG. 8 schematically illustrates an enlarged view of the rising wave shapes of the output voltage VOUT that has been level adjusted. The following explanation is based on the wave shapes shown in FIG. 8. In FIG. 8, as explained above, the wave shape when the touch panel 101 is touched exhibits a slower rise compared to the wave shape when the touch panel 101 is not touched. In FIG. 8, the wave shape when the touch panel 101 is touched is indicated as “Touch” and the wave shape when the touch panel 101 is not touched is indicated as “Non Touch”. In FIG. 8, the vertical direction corresponds to the voltage value and the horizontal direction corresponds to the time. Similarly, in FIGS. 9 and 10 to be explained later, the vertical direction corresponds to the voltage value and the horizontal direction corresponds to the time.

Next, the level-adjusted output voltage is input into the 1-bit sampling unit 108. In the 1-bit sampling unit 108, the level-adjusted output voltage is subjected to 1-bit sampling as described above. Specifically, for example, as shown in FIG. 9, a signal that is at or above a predetermined reference voltage is converted to a high voltage and a signal that is smaller than the predetermined reference voltage is converted to a low voltage. In FIG. 9, the wave shapes shown in FIG. 8 are illustrated with dashed lines for ease of understanding. Herein, as shown in FIG. 9, the wave shape when the touch panel 101 is touched exhibits a slower rise than that when the touch panel 101 is not touched, and thus the timing for changing from low voltage to high voltage differs depending on the presence or absence of a touch. The frequency used in the sampling is preferably set so as to avoid a frequency of noise.

Next, the signal that has been converted by the 1-bit sampling unit 108 is filter processed by the digital filter 109. Specifically, the digital filter 109 is constituted with a low-pass filter, and the signal converted to 1-bit is expanded to 8-bit. This is shown in FIG. 10. In FIG. 10, the wave shapes shown in FIG. 9 are illustrated with dashed lines for ease of understanding. At this time, as shown in FIG. 7, the noise component included after passing through the low-pass filter (LPF) is removed.

Next, the touch determining unit 110 determines whether the touch panel 101 has been touched based on whether the voltage value at the detection timing from the detection timing setting unit 111 is equal to or greater than a predetermined reference value. Specifically, for example, as shown in FIG. 10, since the voltage value differs depending on the presence or absence of a touch on the touch panel 101 at a prescribed timing, the presence of a touch is detected depending on whether the voltage value is equal to or greater than a reference voltage.

According to the present embodiment, primarily, since a portion that is constituted with an analog circuit is constituted by only resistors, the circuit constitution can be simplified compared to the prior art. Further, since charge and discharge to the capacitance are not necessary, the presence of a touch can be detected more quickly. Also, the presence of a touch can be accurately detected by removing the noise with the low-pass filter and the digital filter 109 as described above. In particular, when using the touch panel device 100 as a so-called in-cell-type display device, the amount of noise generated by driving the liquid crystals is large. However, according to the present embodiment, the noise signal is more effectively removed and thus the presence of a touch on the touch panel 101 can be more accurately detected. Thereby, it is not necessary to adjust the timing of the driving of the liquid crystals and the touch panel 101 and the like.

The present invention is not limited to the above-described embodiment, and the above-described embodiment may be replaced with a constitution that is substantially identical to that of the above-described embodiment, a constitution that achieves the same operational effects, or a constitution that achieves the same object.

### Alternative Embodiment

Next, an alternative embodiment of the present invention will be explained. FIG. 11 is a diagram for explaining a touch detector of a touch panel device in an alternative embodiment of the present invention. This alternative embodiment mainly differs from the above-described embodiment in that the touch detector 105 includes an offset setting unit 121 and a gain setting unit 122. In the following, explanations regarding those points which are the same as in the above-described embodiment will be omitted.

As shown in FIG. 11, the touch detector 105 in this alternative embodiment includes, for example, a 1-bit sampling unit 108, a digital filter 109, an offset setting unit 121, a gain setting unit 122, a touch determining unit 110, and a detection timing setting unit 111.

The offset setting unit 121 and the gain setting unit 122 enlarge the level difference between the voltage signals when the touch panel 101 is touched and when the touch panel 101 is not touched at the detection timing by offset adjusting and gain adjusting the voltage signals output from the digital filter 109 in order to enable more accurate determination of the presence of a touch in the touch determining unit 110.

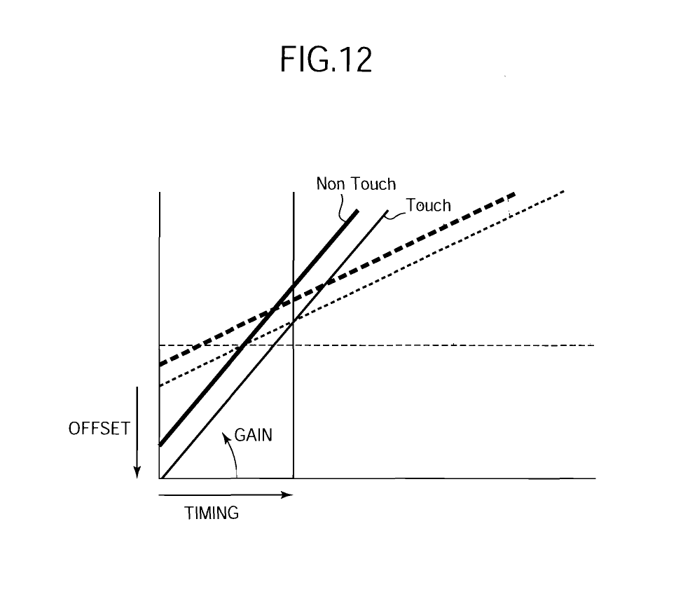

Specifically, as shown in FIG. 12, the wave shapes of the voltage signals output from the digital filter 109 are offset and their inclines (gains) are adjusted. FIG. 12 illustrates the wave shapes when the output signals from the digital filter 109 shown in FIG. 10 are adjusted by the offset setting unit 121 and the gain setting unit 122 as one example. For ease of comparison, the wave shapes shown in FIG. 10 are illustrated with dashed lines in FIG. 12. As can be understood from FIG. 12, the level difference between the touch wave shape when the touch panel 101 is touched and the non-touch wave shape when the touch panel 101 is not touched at the detection timing is enlarged by the above-described adjustments compared to the level difference shown in FIG. 10. Thereby, the touch determining unit 110 can detect the presence of a touch more effectively.

In FIG. 11, a case is illustrated in which the voltage signals from the digital filter 109 are input into the offset setting unit 121 and then the gain setting unit 122 in this order. However, they may also be input in the opposite order, i.e. into the gain setting unit 122 and then the offset setting unit 121. Further, the offset setting unit 121 is constituted with, for example, an adder or a multiplier, and the gain setting unit 122 is constituted with, for example, a multiplier. Also, the above explanation focused on a case in which gain adjustment and offset adjustment are carried out, but a constitution in which only one of the gain adjustment or the offset adjustment is carried out as necessary is also possible.

According to this alternative embodiment, the sensitivity of touch determination can be enhanced compared to the above-described embodiment, and thus the presence of a touch can be more accurately detected.

The present invention is not limited to the above-described embodiment and alternative embodiment, and these embodiments may be replaced with a constitution that is substantially identical to those of the above-described embodiment and alternative embodiment, a constitution that achieves the similar operational effects, or a constitution that achieves the similar object.

For example, in the touch panel device 100 of the above-described embodiment, the touch panel 101 may be an external attachment-type touch panel 101 in which the touch panel 101 is attached to the surface of a liquid crystal panel or the like, or a built-in-type touch panel 101 in which the touch panel 101 is built into a liquid crystal panel. Further, when the touch panel 101 is a built-in-type touch panel 101, the touch panel 101 may be a so-called on-cell-type in which the touch panel 101 is provided between a glass substrate and a polarizer, or an in-cell-type in which a touch function is built into a TFT substrate included in a liquid crystal display device. The touch panel device 100 is also not limited to a liquid crystal display device, and it may be used in other display devices such as an organic EL display device. The first electrode and the second electrode in the claims correspond to, for example, one X electrode 106 and one Y electrode 107 among the plurality of X electrodes 106 and the plurality of Y electrodes 107 described above.

What is claimed is:

1. A touch detection device comprising:
a touch panel including;
a first electrode part arranged so as to extend in a first direction, and
a second electrode part arranged so as to extend in a second direction that is different from the first direction,
a pulse generating unit configured to output a pulse signal to the first electrode part,
a resistance element arranged between an output terminal of the pulse generating unit and the first electrode part, and
a touch detecting unit configured to detect whether the touch panel is touched or not based on a phase difference in a voltage signal of the second electrode part, which is generated in accordance with the pulse signal, wherein the phase difference is based on whether the touch panel is touched or not.

2. The touch detection device according to claim 1, wherein the voltage signal is a voltage signal by a parasitic capacitance of the first electrode part, a parasitic capacitance of the second electrode part, and a capacitance voltage division based on the first electrode part and the second electrode part.

3. The touch detection device according to claim 1, wherein the touch detecting unit comprises:
a sampling unit configured to perform 1-bit sampling of a voltage signal output from the second electrode part based on a predetermined reference value,
a digital filter configured to remove noise included in a voltage signal output from the sampling unit, and
a touch determining unit configured to detect whether the touch panel is touched or not based on a level of a voltage signal output from the digital filter.

4. The touch detection device according to claim 3, wherein the touch detection device further comprises an adjusting unit configured to increase a level difference in the voltage signal output from the digital filter, and
wherein the touch determining unit detects whether the touch panel is touched or not based on a level of a voltage signal output from the adjusting unit.

5. The touch detection device according to claim 4, wherein the adjusting unit includes an offset setting unit configured to offset a voltage value of a voltage signal output from the digital filter.

6. The touch detection device according to claim 4, wherein the adjusting unit includes a gain setting unit configured to adjust a gain of a voltage signal output from the digital filter.

7. The touch detection device according to claim 1, wherein the touch detection device includes a level adjusting unit that is arranged between the second electrode part and the touch detecting unit and adjusts a voltage value of a voltage signal output from the second electrode part.

8. The touch detection device according to claim 1, wherein the first electrode part includes a plurality of first electrodes arranged in a line in the first direction,
the second electrode part includes a plurality of second electrodes arranged in a line in the second direction,
the first electrode part and the second electrode part are arranged to intersect each other, and
the touch detecting unit detects a location of a touch on the touch panel based on each phase difference of each voltage signal of the plurality of second electrodes generated in accordance with pulse signals output to the plurality of first electrodes, wherein the phase difference is based on whether the touch panel is touched or not.

9. The touch detection device according to claim 1, wherein the touch detection device is provided in a TFT substrate of a display device.

10. A display device comprising the touch detection device according to claim 1.

11. A touch detection method of a touch detection device, which comprises a touch panel including a first electrode part arranged so as to extend in a first direction and a second electrode part arranged so as to extend in a second direction that is different from the first direction, and a resistance element arranged between an output terminal of a pulse generating unit and the first electrode part, comprising:
outputting a pulse signal to the first electrode part, and
detecting whether the touch panel is touched or not based on a phase difference in a voltage signal of the second electrode part, which is generated in accordance with the pulse signal, wherein the phase difference is based on whether the touch panel is touched or not.
